(19) United States
(12) Patent Application Publication
(10) Pub. No.: US 2025/0215944 A1
(43) Pub. Date: Jul. 3, 2025

(54) BRAKE CALIPER HOUSING FOR FRICTION STIR WELDING

(71) Applicant: CCYS HI-TECH INTERNATIONAL LTD., TAICHUNG CITY (TW)

(72) Inventor: SHENG-YU WANG, TAICHUNG CITY (TW)

(73) Assignee: CCYS HI-TECH INTERNATIONAL LTD., TAICHUNG CITY (TW)

(21) Appl. No.: 18/431,614

(22) Filed: Feb. 2, 2024

(30) Foreign Application Priority Data
Jan. 3, 2024 (TW) 113200100

(51) Int. Cl. F16D 65/00; F16D 55/00

(52) U.S. Cl. CPC F16D 65/0087; F16D 55/00; F16D 65/0075; F16D 2055/002; F16D 2250/0076

(57) ABSTRACT

A brake caliper housing includes a left shell having a left connecting surface, and a right shell having a right connecting surface. The left connecting surface has at least one positioning hole, and the right connecting surface protrudes with at least one positioning pin inserted into the at least one positioning hole, such that the left connecting surface is abutted against and aligned with the right connecting surface. The right connecting surface is fixedly connected with the left connecting surface by a friction stir welding. As a result, during the friction stir welding, the left and right shells can be precisely aligned and joined together.

### BACKGROUND OF THE INVENTION

### 1. Field of the Invention

The present invention relates generally to brake caliper housings, particularly to a brake caliper housing suitable for being made by friction stir welding. The left and right shells of the brake caliper housing can be precisely aligned and positioned with each other, thereby facilitating performance of the friction stir welding.

### 2. Description of the Related Art

The brake caliper housing for hydraulic disc brakes used in general vehicles is mainly composed of a left shell and a right shell, which are mutually locked and fixed with each other by bolts. For this two-piece brake caliper housing, because the left and right shells can be made separately, the mold design and manufacturing of the left and right shells are relatively easier compared to the integrally forged one-piece brake caliper housing. However, as the left and right shells are locked and fixed by bolts, additional machining process for making threaded holes is required after the casting of the left and right shells is completed, resulting in increase of the processing steps. Moreover, to ensure stable and desired locking strength of the two-piece brake caliper housing under long-term use and vibration, the bolt locking structure requires special design considerations and the bolt locking strength must be maintained in a certain locking torque range, thereby increasing component and assembly costs.

In an attempt to address the above issues, a traditional method of welding the left and right shells may be used. However, traditional welding methods using welding materials and flux to weld the skin surfaces of the workpieces may have mechanical strength concerns, especially for brake caliper housings having complex three-dimensional shapes and receiving reaction forces from the hydraulic caliper braking disc. On the other hand, the friction stir welding, due to its superior mechanical properties compared to traditional welding methods and its ability to weld difficult-to-weld materials, such as aluminum, magnesium, copper, titanium, or steel, and to weld workpieces of different materials, it has been widely used in recent years in automotive manufacturing, aerospace industry, and electronic industry. However, to perform the friction stir welding on various workpieces, the challenges such as weld bead design, jig design, and fixture design must be first addressed. For workpieces having simple geometric shape like two-dimensional plates, the aforementioned jig and fixture designs are relatively straightforward. However, for brake caliper housings having complex three-dimensional geometric shapes, the designs of jigs and fixtures become comparatively complex. Particularly, how to ensure precise alignment and secure clamping of the left and right shells of a brake caliper housing having complex three-dimensional geometric shapes so as to facilitate the performance of the friction stir welding is a crucial challenge that needs to be overcome.

### SUMMARY OF THE INVENTION

The present invention has been accomplished in view of the above-noted circumstances. It is an objective of the present invention to provide a brake caliper housing, which is adapted for being made by the friction stir welding, having a unique positioning mechanism, such that the left and right shells can be precisely aligned and positioned with each other, thereby facilitating performance of the friction stir welding.

To attain the above objective, the present invention provides a brake caliper housing comprising a left shell having a left connecting surface, and a right shell having a right connecting surface. The left connecting surface has at least one positioning hole, the right connecting surface protrudes with at least one positioning pin, and the at least one positioning pin is inserted into the at least one positioning hole, such that the left connecting surface is abutted against and aligned with the right connecting surface. The right connecting surface is fixedly connected with the left connecting surface by a friction stir welding.

With the above-mentioned technical features, i.e., the positioning mechanism of providing positioning pins and positioning holes on and between the left connecting surface and the right connecting surface, the left shell and the right shell can be precisely aligned and connected with each other without the need of jigs, thereby facilitating the clamping of the left shell and the right shell for preforming the subsequent friction stir welding.

Preferably, the right connecting surface may have at least one positioning hole, and the at least one positioning pin is inserted into the at least one positioning hole of the right connecting surface in a way that the at least one positioning pin protrudes from the right connecting surface. In other words, both the right connecting surface and the left connecting surface are designed with positioning holes, and the positioning pin is a separate member. The positioning pin is initially inserted into the positioning hole of the right connecting surface, protruding from the right connecting surface (or it can be inserted into the positioning hole of the left connecting surface, protruding from the left connecting surface). During alignment, the positioning pin is then inserted into the other positioning hole. In this way, the alignment mechanism of the present invention can be directly applied to existing, previously mentioned two-piece brake caliper housings in the state of art. By means of simple processing and assembly, the technical features of the present invention can be applied to existing two-piece brake caliper housings.

Additionally, the positioning pin can be designed with a different material than the left and right shell, facilitating assembly.

Preferably, the right shell may be monolithically formed with the at least one positioning pin. Alternatively, the left shell may be monolithically formed with the at least one positioning pin. In this way, some processing and assembling steps may be omitted to save time and labor.

Preferably, the left shell comprises a main body, a front extension segment extending from a top edge of the main body toward the right shell, and a rear extension segment extending from the top edge of the main body toward the right shell and being spaced from the front extension segment. The front extension segment has an end face facing the right shell, and the rear extension segment has an end face facing the right shell. The end faces of the front and rear extension segments collectively form the left connecting surface. The right shell comprises a main body, a front extension segment extending from a top edge of the main body of the right shell toward the left shell, and a rear extension segment extending from the top edge of the main body of the right shell toward the left shell and being spaced from the front extension segment of the right shell. The front extension segment of the right shell has an end face facing the left shell, and the rear extension segment of the right shell has an end face facing the left shell. The end faces of the front and rear extension segments of the right shell collectively form the right connecting surface. By aligning the front and rear extension segments of the left and right shells with each other, the alignment can be conducted in a more precise and secure manner.

Preferably, the left shell comprises a mounting protrusion protruding in a direction away from the right shell, and the right shell comprises a mounting protrusion protruding in a direction away from the left shell. In this way, the mounting protrusions of the left and right shells may form a holding structure adapted for being clamped by a fixture, such that the left and right shells can be firmly clamped in position to facilitate the performance of the friction stir welding.

Preferably, the left shell comprises a main body having a top edge and a bottom edge. The mounting protrusion of the left shell has a top edge lower than the top edge of the main body. The top edge of the mounting protrusion of the left shell and the bottom edge of the main body respectively form holding surfaces adapted for being clamped by a fixture. In this way, the left shell is provided with an upper holding surface and a lower holding surface, such that the left shell can be firmly and stably clamped in position.

Preferably, the right shell comprises a main body having a top edge and a bottom edge. The mounting protrusion of the right shell has a top edge lower than the top edge of the main body of the right shell. The top edge of the mounting protrusion of the right shell and the bottom edge of the main body of the right shell respectively form holding surfaces adapted for being clamped by a fixture. In this way, the right shell is provided with an upper holding surface and a lower holding surface, such that the right shell can be firmly and stably clamped in position.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective assembled view of a brake caliper housing according to an embodiment of the present invention;

FIG. 2 is a partially exploded view of the brake caliper housing of the embodiment of the present invention, showing positioning pins protruding from a right connecting surface of a right shell;

FIG. 3 is another exploded view of the brake caliper housing of the embodiment of the present invention;

FIG. 4 is still another exploded view of the brake caliper housing of the embodiment of the present invention;

FIG. 5 is a cross-sectional view taken along line 5-5 of FIG. 1;

FIG. 6 is a schematic perspective view, showing a rotating shoulder tool used in the friction stir welding moves along the connecting surfaces; and

FIG. 7 is a schematic front view, showing the rotating shoulder tool used in the friction stir welding moves along the connecting surface, in which the left shell is omitted.

### DETAILED DESCRIPTION OF THE INVENTION

First of all, it is to be mentioned that same or similar reference numerals used in the following embodiments and the appendix drawings designate same or similar elements or the structural features thereof throughout the specification for the purpose of concise illustration of the present invention. It should be noticed that for the convenience of illustration, the components and the structure shown in the figures may be not drawn according to the real scale and amount, and the features mentioned in each embodiment can be applied in the other embodiments if the application is possible in practice. Besides, when it is mentioned that an element is disposed on another element, it means that the former element is directly disposed on the latter element, or the former element is indirectly disposed on the latter element through one or more other elements between aforesaid former and latter elements. When it is mentioned that an element is directly disposed on another element, it means that no other element is disposed between aforesaid former and latter elements. Furthermore, the directional descriptions, such as front, rear, left, right, up, and down, mentioned in the present invention are used as references for illustrating the technical features of the present invention only, and thus are not limitative of the present invention.

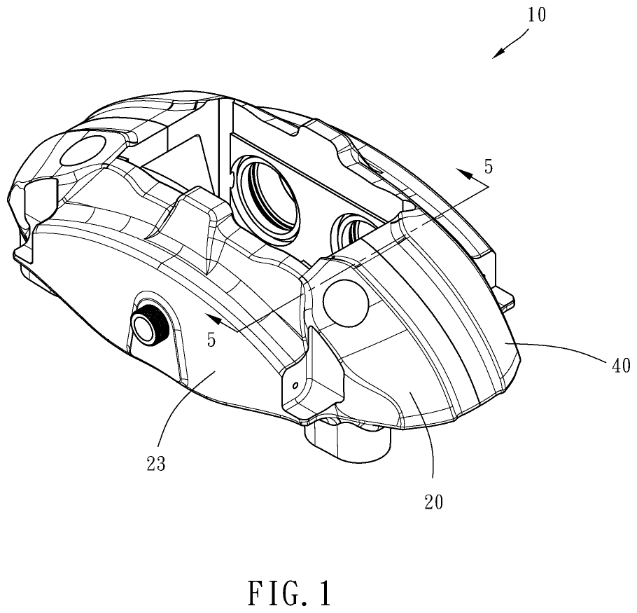

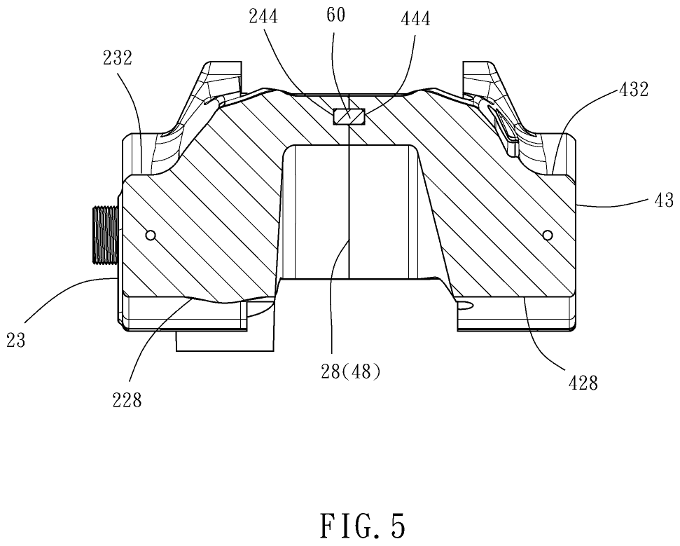

Referring to FIGS. 1 to 5, a brake caliper housing 10 provided by a preferred embodiment of the present invention is mainly composed of a left shell 20 and a right shell 40. The left and right shells 20 and 40 are provided with a unique alignment mechanism, making them particularly suitable for being securely fixed as unitary member by the so-called friction stir welding. The detailed structural design is described as follows.

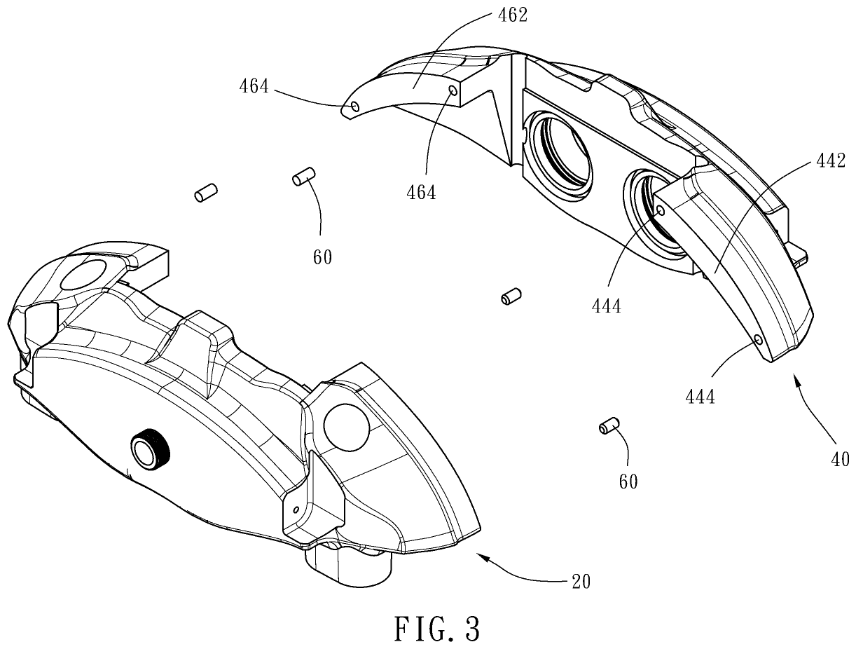

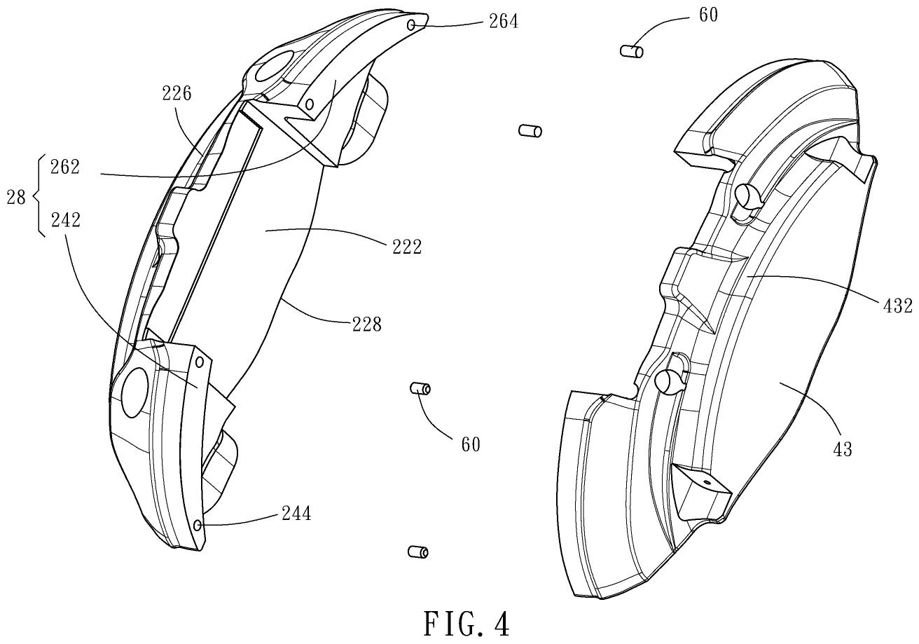

As shown in FIGS. 3 and 4, the left shell 20 includes a main body 22, a front extension segment 24, and a rear extension segment 26. The main body 22 has an inner side surface 222 facing the right shell 40, an outer side surface 224 opposite to the inner side surface 222, a top edge 226, and a bottom edge 228. The central position of the outer side surface 224 has a mounting protrusion 23 projecting in a direction away from the right shell 40. The top edge 232 of the mounting protrusion 23 is lower than the top edge 226 of the main body 22, such that the top edge 232 of the mounting protrusion 23 and the bottom edge 228 of the main body 22 respectively form holding surfaces adapted for being clamped by a fixture (not shown). The front extension segment 24 extends from the front side of the top edge 226 of the main body 22 towards the right shell 40, and the rear extension segment 26 extends from the rear side of the top edge 226 of the main body 22 towards the right shell 40 and spaced from the front extension segment 24 at a predetermined distance. The front extension segment 24 has an end face 242 facing the right shell 40, and the end face 242 is provided with two positioning holes 244 spaced from each other. Similarly, the rear extension segment 26 has an end face 262 facing the right shell 40, and the end face 262 is provided with two positioning holes 264 spaced from each other. In addition, the end face 242 of the front extension segment 24 and the end face 262 of the rear extension segment 26 are coplanar to collectively form a left connecting surface 28.

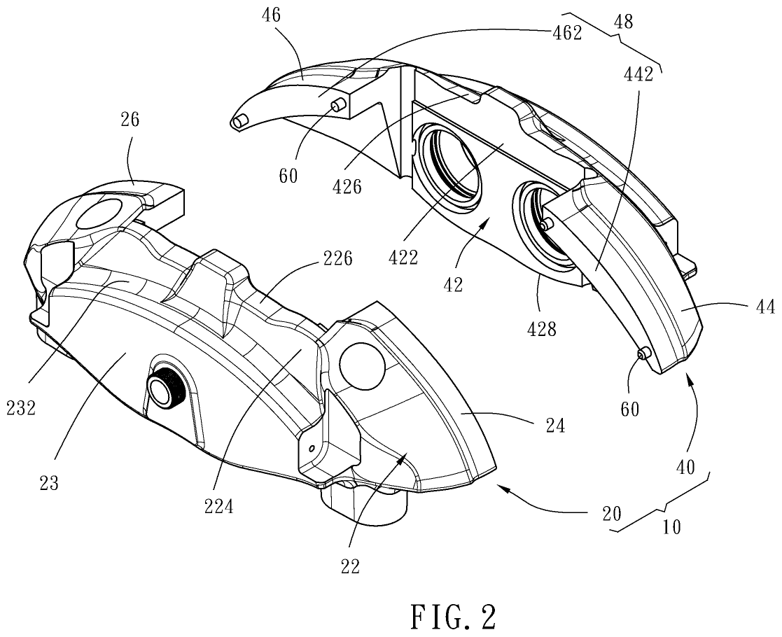

As shown in FIGS. 2 to 4, the right shell 40 includes a main body 42, a front extension segment 44, and a rear extension segment 46. The main body 42 has an inner side surface 422 facing the left shell 20, an outer side surface 424 opposite to the inner side surface 422, a top edge 426, and a bottom edge 428. The central position of the outer side surface 424 has a mounting protrusion 43 projecting in a direction away from the left shell 20. The top edge 432 of the mounting protrusion 43 is lower than the top edge 426 of the main body 42. The top edge 432 of the mounting protrusion 43 and the bottom edge 428 of the main body 42 respectively form holding surfaces adapted for being clamped by a fixture (not shown). The front extension segment 44 extends from the front side of the top edge 426 of the main body 42 towards the left shell 20, and the rear extension segment 46 extends from the rear side of the top edge 426 of the main body 42 towards the left shell 20 and spaced from the front extension segment 44 at a predetermined distance. The front extension segment 44 has an end face 442 facing the left shell 20, and the end face 442 is provided with two positioning holes 444 corresponding to the positioning holes 244 of the left shell 20. Similarly, the rear extension segment 46 has an end face 462 facing the left shell 20, and the end face 462 is provided with two positioning holes 464 corresponding to the positioning holes 264 of the left shell 20. In addition, the end face 442 of the front extension segment 44 and the end face 462 of the rear extension segment 46 are coplanar to form a right connecting surface 48.

As shown in FIGS. 2, 3 and 5, in this embodiment, the brake caliper housing 10 further comprises four positioning pins 60, which may have the same material as the left shell 20 or the right shell 40 or different materials. In assembly, the positioning pins 60 are first inserted into the positioning holes 444, 464 of the right shell 40 in a tight fit manner, causing them to partially protrude from the right connecting surface 48. Subsequently, when the left shell 20 and the right shell 40 need to be aligned and joined with each other for the friction stir welding process, the parts of the positioning pins 60 protruding from the right connecting surface 48 are directly inserted into the positioning holes 244, 264 of the left shell 20. In this way, the left connecting surface 28 and the right connecting surface 48 can be firmly abutted against each other to achieve precise alignment and coupling.

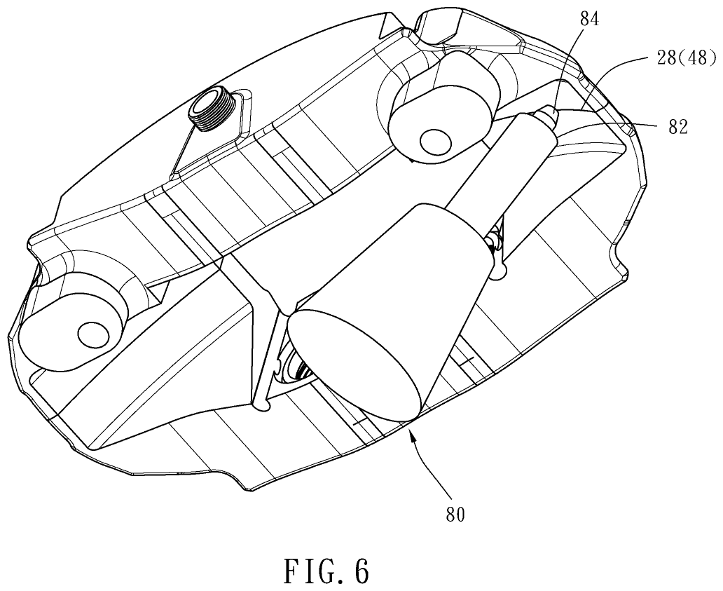

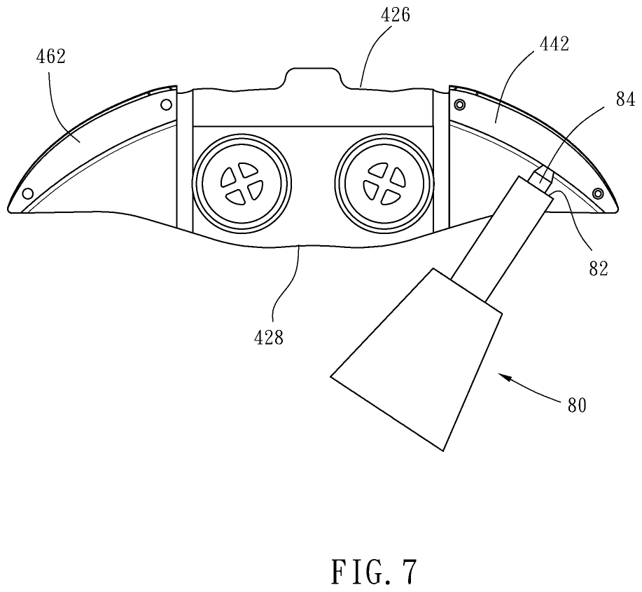

FIGS. 6 and 7 schematically depict the scenario of a rotating shoulder tool 80 used in the friction stir welding and performing the welding task on the brake caliper housing 10 provided by the embodiment of the present invention. The rotating shoulder tool 80 has a shoulder portion 82 and a stirring rod 84 extending outward from the shoulder portion 82. During the process of the friction stir welding, the stirring rod 84 rotates and enters in between the left connecting surface 28 and the right connecting surface 48 first, and then continuously move deeper until the shoulder portion 82 contacts the surfaces of the left shell 20 and the right shell 40 adjacent to the left connecting surface 28 and the right connecting surface 48. At this point, the frictional heat generated by the rotation of the rotating shoulder tool 80 makes the to-be-weld metal materials around the shoulder portion 82 and the stirring rod 84 softened. As the rotating shoulder tool 80 rotates and moves along the joint of the left connecting surface 28 and the right connecting surface 48, the hot and softened metal material around the left connecting surface 28 of the left shell 20 and the right connecting surface 48 of the right shell 40 is stirred and intermixed together. After cooling, a dense weld bead is formed, fixedly securing the left shell 20 and the right shell 40 together. As the friction stir welding is a known technology, the processing principles and welding steps are not necessarily elaborated here.

From the description above, as the brake caliper housing 10 provided by the embodiment of the present invention has a positioning mechanism with positioning pins 60 and positioning holes 244, 264, 444, 464 on between the left connecting surface 28 and the right connecting surface 48, the left shell 20 and the right shell 40 can be easily and precisely aligned and positioned with each other without the need of jigs. This facilitates further clamping of the already aligned left shell 20 and right shell 40 to the machine worktable for performing subsequent friction stir welding. Secondly, as mentioned above, the left shell 20 is designed with a mounting protrusion 23, and the right shell 40 is similarly designed with a mounting protrusion 43. Specifically, the top edge 232 of the mounting protrusion 23 of the left shell 20 and the bottom edge 228 of the main body 22 form holding surfaces, while the top edge 432 of the mounting protrusion 43 of the right shell 40 and the bottom edge 428 of the main body 42 also form holding surfaces. This design helps to securely clamp the already aligned left shell 20 and right shell 40 to the machine worktable for smoothly performing the friction stir welding.

It will be appreciated that in this embodiment, the positioning pins 60 belong to different components from the left shell 20 and the right shell 40. However, the present invention is not limited to this design. For example, in another embodiment of the present invention, the right shell 40 may be monolithically formed with one or more protruding positioning pins 60 on the right connecting surface 48, eliminating the need of providing positioning holes 444 and 464 as long as the left connecting surface 28 is provided with the positioning holes 244 and 264. Alternatively, in another embodiment of the present invention, the left shell 20 may be monolithically formed with one or more protruding positioning pins 60 on the left connecting surface 28, eliminating the need of providing positioning holes 244 and 264 as long as the right connecting surface 48 is provided with the positioning holes 444 and 464. Furthermore, the present invention is not limited to the design that the protruding positioning pins 60 are provided on the right connecting surface 48, and the positioning holes 244 and 264 are provided on the left connecting surface 28. For example, the positioning pins 60 and positioning holes 444 and 464 may be simultaneously provided on the right connecting surface 48, and correspondingly the positioning pins 60 and positioning holes 244 and 264 may be simultaneously provided on the left connecting surface 28, such that mutual alignment of the left connecting surface 28 and the right connecting surface 48 can also be achieved. Alternatively, in another embodiment, the positioning pins 60 may be provided on the left connecting surface 28, and the positioning holes 444, 464 for accommodating the positioning pins 60 may be provided on the right connecting surface 48, thereby achieving the objective of the present invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A brake caliper housing, comprising:
a left shell having a left connecting surface; and
a right shell having a right connecting surface;
wherein the left connecting surface has at least one positioning hole, the right connecting surface protrudes with at least one positioning pin, and the at least one positioning pin is inserted into the at least one positioning hole, such that the left connecting surface is abutted against and aligned with the right connecting surface;
wherein the right connecting surface is fixedly connected with the left connecting surface by a friction stir welding.

2. The brake caliper housing as claimed in claim 1, wherein the right connecting surface has at least one positioning hole, and the at least one positioning pin is inserted into the at least one positioning hole of the right connecting surface in a way that the at least one positioning pin protrudes from the right connecting surface.

3. The brake caliper housing as claimed in claim 1, wherein the right shell is monolithically formed with the at least one positioning pin.

4. The brake caliper housing as claimed in claim 1, wherein:
the left shell comprises a main body, a front extension segment extending from a top edge of the main body toward the right shell, and a rear extension segment extending from the top edge of the main body toward the right shell and being spaced from the front extension segment; the front extension segment has an end face facing the right shell, and the rear extension segment has an end face facing the right shell; the end faces of the front and rear extension segments collectively form the left connecting surface; and
the right shell comprises a main body, a front extension segment extending from a top edge of the main body of the right shell toward the left shell, and a rear extension segment extending from the top edge of the main body of the right shell toward the left shell and being spaced from the front extension segment of the right shell; the front extension segment of the right shell has an end face facing the left shell, and the rear extension segment of the right shell has an end face facing the left shell; the end faces of the front and rear extension segments of the right shell collectively form the right connecting surface.

5. The brake caliper housing as claimed in claim 4, wherein the left shell comprises a mounting protrusion protruding in a direction away from the right shell, and the right shell comprises a mounting protrusion protruding in a direction away from the left shell.

6. The brake caliper housing as claimed in claim 5, wherein the main body of the left shell comprises a bottom edge; the mounting protrusion of the left shell has a top edge lower than the top edge of the main body of the left shell; the top edge of the mounting protrusion of the left shell and the bottom edge of the main body of the left shell respectively form holding surfaces to be clamped by a fixture.

7. The brake caliper housing as claimed in claim 6, wherein the main body of the right shell comprises a bottom edge; the mounting protrusion of the right shell has a top edge lower than the top edge of the main body of the right shell; the top edge of the mounting protrusion of the right shell and the bottom edge of the main body of the right shell respectively form holding surfaces to be clamped by the fixture.

8. The brake caliper housing as claimed in claim 1, wherein the left shell comprises a mounting protrusion protruding in a direction away from the right shell, and the right shell comprises a mounting protrusion protruding in a direction away from the left shell.

9. The brake caliper housing as claimed in claim 8, wherein the left shell comprises a main body having a top edge and a bottom edge; the mounting protrusion of the left shell has a top edge lower than the top edge of the main body of the left shell; the top edge of the mounting protrusion of the left shell and the bottom edge of the main body of the left shell respectively form holding surfaces to be clamped by a fixture.

10. The brake caliper housing as claimed in claim 9, wherein the right shell comprises a main body having a top edge and a bottom edge; the mounting protrusion of the right shell has a top edge lower than the top edge of the main body of the right shell; the top edge of the mounting protrusion of the right shell and the bottom edge of the main body of the right shell respectively form holding surfaces to be clamped by the fixture.
